(19) United States
(12) Patent Application Publication
(10) Pub. No.: US 2009/0096606 A1
(43) Pub. Date: Apr. 16, 2009

(54) Remote obstruction sensing device

(75) Inventors: Joel Edward Janov, Evergreen, CO (US); Carl Arthur Craig, Evergreen, CO (US); Marc Lee Denis, Lena, WI (US)

Correspondence Address: REILLY INTELLECTUAL PROPERTY LAW FIRM, 1325 East 16th Avenue, DENVER, CO, 80218, US

(73) Assignee: Remote Logics, Inc.

(21) Appl. No.: 11/974,059

(22) Filed: Oct. 11, 2007

(51) Int. Cl. H04K 3/00

(52) U.S. Cl. 340/540; 455/1

(57) ABSTRACT

A novel and improved remote object sensing device and method that is capable of sensing the presence of an object, transmitting a blocking signal to a remote control or communication member thereby preventing activation of a garage door opener circuit.

### BACKGROUND AND FIELD

This apparatus relates to remote sensing systems for sensing obstructions and more particularly relates to a novel and improved remote control device and method that operate to block or interrupt a command signal, for example, to open a garage door or other access way when an obstruction is present.

A common problem for bicycle enthusiasts, kayakers, vehicle operators and the like, is neglecting to remove an object mounted on the roof of the vehicle prior to entering a garage where there is insufficient clearance between the object and the doorway leading into the garage. Typically, the operator drives into the garage, striking the object against the top of the garage opening, causing damage or complete destruction to the object as well as the doorframe and possibly the vehicle. A number of systems have been devised in an attempt to warn or alert a driver that the clearance at the top of the garage door is insufficient to enable an article on the roof of the vehicle to enter the space and generally requires a transmitter, receiver and a form of alarm or a form of computer to measure the distance between an obstacle and the clearance height. These systems typically require a signal to trigger an alarm within the vehicle alerting the operator of an obstruction but do not prevent or block transmission of the signal to the garage door opener. Accordingly, there is a need for an integrated system that interrupts or blocks the remote signal from the vehicle to the garage door opener circuit thereby preventing the garage door from opening whenever an obstructing article or object is mounted on the vehicle.

### SUMMARY

The present embodiments and aspects provide an integrated system for preventing a garage door electrical opener circuit from opening a garage door when an obstruction is present on a vehicle. Broadly, in a control system for a garage door electrical opener circuit in which a control signal is transmitted remotely from a vehicle to a receiver in the opener circuit within a garage for opening and closing the garage door, the system comprising remote control means for transmitting the control signal, and means on the vehicle for blocking the control signal to the opener circuit or to transmit a signal that bypasses the remote control and blocks the operation of the garage door. There is a method of interrupting or blocking a garage door activation signal to an opener circuit, the signal normally causing the opener circuit to open a garage door, the method comprising a blocking member on an exterior of the vehicle which blocks the activation signal in response to an obstruction being within range of the blocking member; or transmitting a signal directly to the opener circuit in the garage to prevent opening of the garage door in response to activation of the remote control signal.

In addition to the apparatus described above, further aspects and embodiments will become apparent by reference to the drawings and by study of the following descriptions. Exemplary embodiments are illustrated in reference to Figures of the drawings. It is intended that the embodiments and Figures disclosed herein are to be considered illustrative rather than limiting.

### BRIEF DESCRIPTIONS OF THE DRAWINGS

FIG. 1 is a block diagram demonstrating a first embodiment;

FIG. 2 is a block diagram of a second embodiment;

FIG. 3 is a block diagram demonstrating a third embodiment;

FIG. 4 is a block diagram demonstrating a fourth embodiment;

FIG. 5 is a block diagram demonstrating a fifth embodiment;

FIG. 6 is a block diagram demonstrating a sixth embodiment;

FIG. 7 is a perspective view of an integrated sensor.

Exemplary embodiments are illustrated in referenced Figures of the drawings. It is intended by the embodiments and Figures disclosed herein are to be considered illustrative rather than limiting.

### DETAILED DESCRIPTION OF FIRST EMBODIMENT

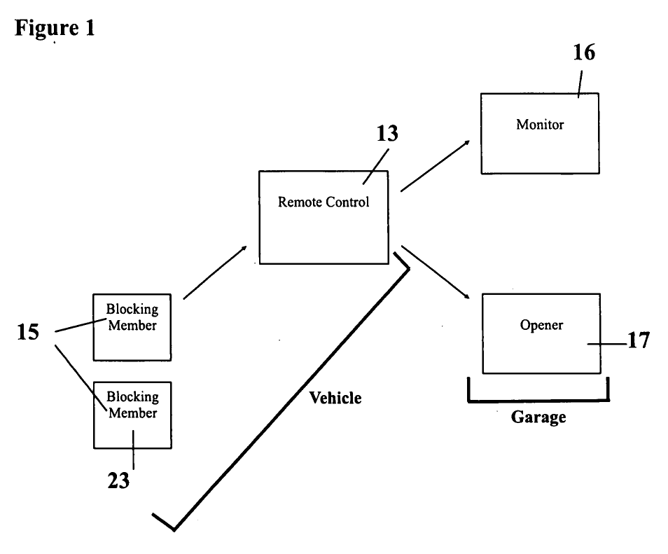

A novel and improved remote sensor device is schematically shown in FIG. 1 and is broadly comprised of a remote control member 13, located within a vehicle, that is adapted to generate a wireless control signal; a blocking member 15, located in or on an exterior of the same vehicle, that blocks the control signal to a garage door electrical opener circuit 17. The garage door electrical opener circuit 17 is located within a garage and possesses a receiver 12 designed to receive the wireless control signal from the remote control member 13 and activate the opener circuit 17. If an obstruction such as a bicycle, kayak, canoe, ladder or any other type of object is present on the vehicle exterior and detected by the blocking member 15, the blocking member 15 generates a signal to interrupt the transmission of the wireless control signal from the remote control member 13 to the opener circuit 17, thereby preventing the receiver 12 from opening the garage door. The remote control member 13 may alternatively be hardwired so as to receive different forms of signals from the blocking member 15. The remote control member 13 may be housed in a simple, lightweight housing similar to a remote control for a garage door opener and is designed to receive one or more signals from the blocking member 15.

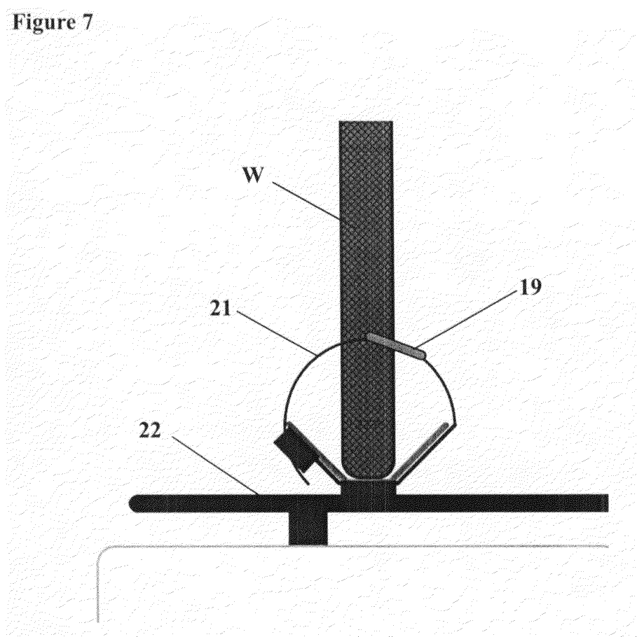

The blocking member 15 is typically located in or on the roof of a vehicle and, for example but not by way of limitation, may be an integrated device designed to sense, indicate or signal the presence of an obstruction and having a sensor module that transmits a wireless signal to the remote control member 13 within the vehicle to indicate that an object is mounted on the roof of the vehicle. For example, in the case of a bicycle, the member 15 may be a tactile ribbon switch 19 integrated into a wheel strap 21 and mounted on a bike rack 22 as shown in FIG. 7. When the wheel strap 21 is tightened down on a bike wheel W the ribbon switch 19 is closed and a signal is transmitted indicating that a bike or other article is present. The blocking member 15 typically provides a particular radio frequency (RF) carrier frequency and may shift to low duty cycling when no obstruction is present. Other forms of signals may also be used such as optical, ultrasonic, a frequency hopping spread spectrum (FHSS) or a direct sequence spread spectrum (DSSS) that spreads the energy of the communication signal over a wider range of frequencies. Ultra-wideband techniques spread the signal over a very large frequency range.

The sensor module may be attached to the rack 22, to an article stored in the rack 22 or to any other overhead rack used for different articles, such as, luggage, canoes, kayaks and acts as a detecting instrument or member that is capable of detecting and responding to physical stimuli such as weight, movement, light or heat. Other forms of sensors that may be used include, but are not limited to, inductive, capacitive, ultrasonic or optical (infrared or LED) sensors.

The blocking member 15 may appear in a number of different forms so as to accommodate different types of objects as well as different types of rack systems. For example, but not by way of limitation, a form of clamp sensor may be integrated into a fork mount clamp 25 of the bike rack 22. A bike tire switch incorporating a simple tactile button or ribbon switch that is adhered to a bike tray and closed by the weight of the bike transmitted through the bike tire may also be used. A passive capacitive sensor consisting of two or more pads on a thin printed substrate for providing a source and sink for an electrostatic field, may be used as well. If a bike tire or rim is placed in close proximity to the capacitive sensor, the sensor detects the characteristic change in electrostatic field, the disruption of this field indicating the presence or absence of an object. Another form of sensor is a universal sonar sensor that is a small high frequency sound wave detection device coupled with an electronic switch that can be placed in proximity to a roof rack and any object such as a ladder, luggage rack, ski rack, rear bike rack or kayak and canoe rack. A universal strap sensor that is a switch integrated into a tie down strap, may be used as well. An inductive proximity sensor may be used that detects the presence of various metals other than graphite or Kevlar® rims. Any type of equipment that may be attached to a roof, side, and front or back of a vehicle may also be accommodated with blocking members 15. Further, multiple objects may be secured to one or more blocking members, thereby providing multiple inputs to the remote control member 13. For example, if one has four bike racks on top of the automobile and one single bicycle secured to the one or more blocking members 15, any rack could be occupied and the remote control member will receive a signal that a bicycle is present. A logic circuit 23 may also be integrated with the blocking member 15 or the remote control member 13 and may consist of one or more inputs received from the one or more integrated sensors and a single output that calls for the remote control member 13 to transmit a signal to the opener circuit 17 to open the garage door or provide an interrupt to the signal to open the same garage door if an object is present.

Several options are available for the supply of power to the blocking member(s) 15 such as replaceable batteries, solar/rechargeable batteries having a solar cell attached to the device to provide power to recharge the batteries. The battery life should be sufficient to operate for 30 days without recharge. Also, the device could be hardwired to the vehicle's DC power source. The blocking member 15 may also be powered with a rechargeable battery coupled with a low-battery signal or any other compatible power source.

The electrical opener circuit 17 may be a typical garage door opener that operates as a “learning,” rolling code garage door opener. For example, but not by way of limitation, garage door openers such as the Excelerator, Screw Drive and Chain Glide manufactured by Genie, Alliance, Ohio, may be used or the Craftsman models manufactured by Sears/Craftsman, Hoffman Estates, Ill., and the LiftMaster manufactured by The Chamberlain Group, Inc. of Elmhurst, Ill., may also be used. These are offered once again by way of example and not limitation. The opener circuit 17 is located in the garage and acts to control the movement of a motorized garage door. The interface between the remote control member 13 and the opener circuit 17 may be RF—coded radio frequency signal but other types of signals such as IR—an infrared signal may also be used.

The opener circuit 17 interfaces with the remote control member 13 to receive a signal causing the opener circuit 17, such as an existing power-driven garage door opener, to activate the motor and chain drive or driver member of a garage door, causing the garage door to open. If an obstruction is present, for example a bicycle on the roof of the vehicle, the blocking member 15 generates a signal to the remote control member 13 that operates to block or interrupt a command signal to the opener circuit 17, thereby preventing activation of the motor of the garage door opener.

The remote control member 13 typically has two modes of operation. The normal operation consists of the remote control member 13 interfacing with the blocking member 15 and the opener circuit 17, as described above. The blocking member 15 communicates the presence, or lack of, an object to the remote control member 13. The remote control member 13 will then send a request to the opener circuit 17 to open the garage door if an obstruction is not sensed. The presence of an obstruction will cause interruption of the request from the remote control member 13 to the opener circuit 17. A second mode of operation is bypass operation. In bypass mode the operator is able to operate the opener circuit 17 directly using the remote control member 13 without interfacing with the blocking member 15. The bypass mode operates independent of any input from the blocking member 15. A bypass switch 26 on the remote control member 13 is necessary to allow the operator to, operate the opener circuit 17 directly regardless of the signal from the blocking member 15. The operator will enter into this mode through a combination of actions to prevent the accidental bypass of the remote control member 13. Several options exist for bypass engagement that are offered by way of example and not limitation, flipping up a cover on the remote control member 13 to expose a bypass button or a two button combination that allows the operator to press two buttons simultaneously to operate the bypass.

Alternatively, a door position monitoring device 16 that is typically located within a garage, may be incorporated that will communicate with the remote control member 13 or give an audible signal or warning that the garage door is already open. This safety feature prevents the operator of a vehicle from entering the garage with an obstruction on the roof of the vehicle, when the garage door is already open. If an object is sensed by the blocking member 15, a signal is generated to the remote control member 13 blocking transmission of a signal to the operator circuit 17. The door position monitoring device 16, when in signal range of the remote control member 13, will communicate the status of the garage door, open or closed, to the remote control member 13, thereby notifying the operator with a form of signal, audible or visual, that the garage door is open and an object is present on the vehicle.

Further safety features may include a tamper notification member located near the blocking member 15 on the roof of a vehicle that, if selected by the operator, the blocking member 15 will signal the remote control member 13, or an additional remote receiver, of a change in the state of the blocking member 15 that results from the removal of the object or tampering with the blocking member 15. Another form of tamper notification member results in the blocking member 15 transmitting a signal to a receiver tied into an alarm system of the vehicle. If the object is removed or the blocking member is tampered with, the alarm system will be activated.

### DETAILED DESCRIPTION OF SECOND EMBODIMENT

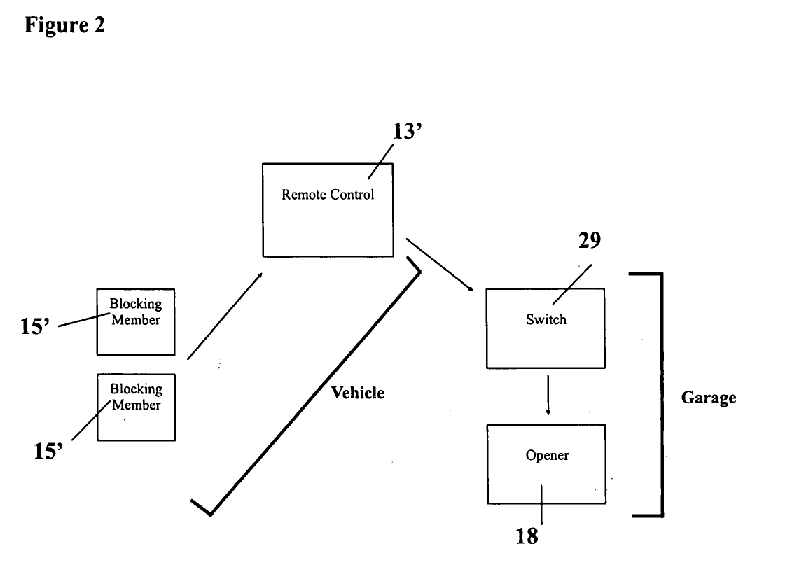

A second embodiment as shown in FIG. 2 consists of three primary components; a remote control member 13′, at least one blocking member 15′, both located in or on a vehicle, and a switch member 29. The wall switch 29 is mounted within an interior of a garage for example; in parallel or replacing an existing wall switch leg of a pre-existing garage door opener or opener circuit 18, as described previously. The one or more blocking members 15′ are typically mounted on an exterior of a vehicle and communicate directly with the remote control member 13′. The remote control member 13′ transmits a signal to the switch member 29 if there is no obstruction. The switch member 29 closes the switch leg and completes the circuit, activating the garage door to open. If an obstruction is sensed or detected, the signal from the blocking member 15′ prevents transmission of a signal to the switch member 29 thereby preventing activation of the opener circuit 18. The interface between the remote control member 13′ and the wall switch 29 may be RF—coded radio frequency signal or IR—infrared signal or any other type of signal that will open or close the switch member 29. The switch member 29 is typically a wall switch that may be driven by battery power or electrical current.

The remote control member 13′ typically has two modes of operation: The normal operation consists of the operation as set forth above. The blocking member 15′ communicates the presence or absence of an object to the remote control member 13′ which in turn will transmit or fail to transmit a signal to the switch member 29, dependant upon the signal generated by the blocking member 15′, and thereby activate or prevent activation of the control circuit of the garage door opener 18. In bypass mode, the operator is able to operate the garage door opener 18 directly regardless of the input from the blocking member 15′. The operator will enter into this mode through a combination of actions to prevent the accidental bypass of the blocking member 15′. For example, a hinged cover on the remote control member 13′ may be flipped up by the operator to expose a bypass button. Another option is a two-button combination whereby the operator can hit two buttons simultaneously to operate the bypass.

A typical operation requires an operator to press a touch pad or button on the remote control member 13′ that either transmits or fails to transmit a wireless radio signal to the wall switch 29 dependant upon the signal transmitted by the blocking sensor 15′. The wall switch 29 will be security coded to operate only with the individual learned remote control member 13′ provided with the system. If an object is present and detected by the blocking member 15′, a signal is transmitted to the remote control member 13′ indicating the presence of an object. Attempts to transmit a signal from the remote control member 13′ to the switch member 29 will fail and the opener circuit 18 will not be activated. If an obstruction is not sensed by the blocking member 15′, a different signal is generated to the remote control member 13′ and in turn a signal is transmitted to the switch member 29 causing the switch leg of the opener circuit 18 to close, thus activating the garage door opener.

The embodiment described herein also may include all of the safety features and additional features previously described such as a door position monitoring device and a tamper notification member.

### DETAILED DESCRIPTION OF THIRD EMBODIMENT

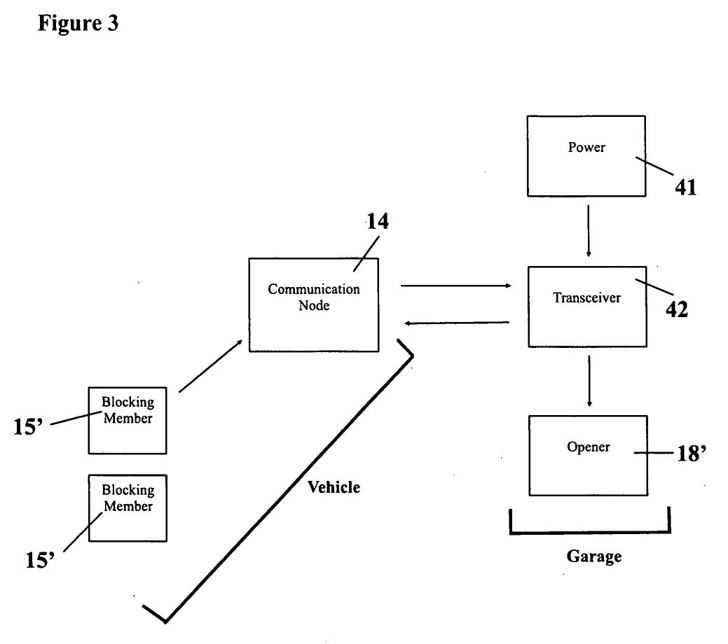

Another embodiment, as shown in FIG. 3, is made up of four primary components, a communication node 14 located within a vehicle, one or more paired blocking members 15′ located in or on an exterior of the same vehicle, a transmitter/receiver or transceiver 42 and a power interrupt device 41 both located within a garage. The power interrupt device 41 plugs inline with the power supply for an existing garage door opener 18′. The blocking members 15′ are as previously described and transmit a signal to the communication node 14, dependant upon the presence or absence of an obstruction. The communication node 14 acts as a receiver listening for a known signal from the blocking member 15′ as well as from the transceiver unit 42. The transceiver 42 acts as a radio beacon transmitter as well as controlling an AC relay. The beacon transmitter is an RF transmitter, preferably digital, that is set to a particular frequency. The limited range inherent in the transmitter will allow the transceiver 42 to act as a range limited beacon, providing a proximity warning. The detection of the beacon signal by the communication node 14 triggers a response from the communication node 14 to the transceiver 42. If a response is received by the transceiver 42, the AC relay for the garage door opener 18′ will be disabled. Removal of the AC power, prevents the garage door opener from responding to the remote control signal, thereby preventing the garage door from opening.

The blocking members 15′ may be in ‘sleep’ mode, waking when activated and the vehicle is in range of the transceiver 42. The blocking members 15′ periodically listen for a polling request from the communication node 14. This polling request takes place in conjunction with a beacon signal S from the transceiver 42. Thus, the blocking members 15′ only transmit and consume the greatest current when the system is in proximity to the transceiver 42. The communication node 14 likewise is typically in ‘sleep’ mode, waking periodically to listen for the beacon signal S. The “wake-sleep’ cycle can be specified for a determined latency time allowing a set period between the signal transmitted by the beacon and the time the communication node 14 transmits a response.

An additional safety feature involves inclusion of an alarm that is triggered by the beacon signal S as well and is located within the vehicle. If the garage door is already open, even though the AC relay opens, the garage door remains open. In this situation, an alarm within the vehicle will alert the driver of an obstruction.

This embodiment relies on the customers existing garage door remote control or remote transmitting member 22 and garage door opener 18′. The blocking members 15′ communicate a status signal to the communication node 14; the transceiver 42 transmits the beacon signal and if detected by the communication node 14, triggers a response. If a response is detected by the transceiver 42, the AC relay for the garage door opener 18′ is disabled, preventing the garage door from opening. Under normal operation, the system will act as described above. In bypass mode, the operator is able to operate the garage door opener 18′ directly without interfacing with the communication node 14. The operator will enter into this mode through a combination of buttons on the communication node 14 as described previously. The embodiment described herein also may include all of the safety features and additional features previously described including an alarm that is triggered by the beacon signal S and is contained within the vehicle or in close proximity to the garage door. If the garage door is already open upon approach by a vehicle, the alarm function will alert the driver to prevent collision with the garage doorframe.

### DETAILED DESCRIPTION OF FOURTH EMBODIMENT

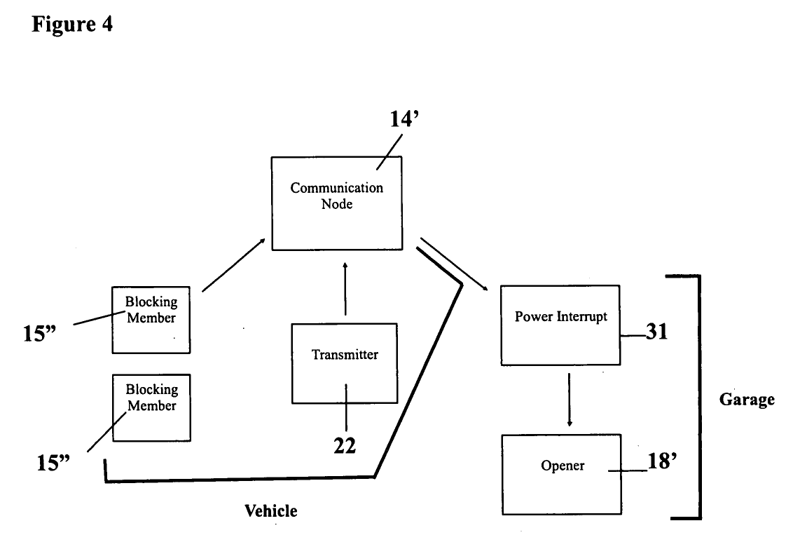

Another embodiment, as shown in FIG. 4, is made up of three primary components, a communication node 14′ located within a vehicle, one or more paired blocking members 15″ located on an exterior of the same vehicle, and a power interrupt device 31 located within a garage. The power interrupt device 31 plugs inline with the power supply for an existing garage door opener 18′. Upon request from the communication node 14′, the power interrupt device 31 temporarily interrupts the power to the garage door opener 18′ thereby resetting the garage door opener 18′ and preventing the garage door from opening. This embodiment relies on the customers existing garage door remote control or remote transmitting member 22 and garage door opener 18′. The blocking member 15″ communicates a status signal to the communication node 14′, and dependant upon the blocking members' condition and a detected signal from the garage door remote control to open the garage door, the communication node 14′ will transmit a request to interrupt the power supply to the power interrupt device 31. This brief interruption in power to the garage door opener 18′ will reset the garage door and prevent it from opening. Under normal operation, the system will act as described above. In bypass mode, the operator is able to operate the garage door opener 18′ directly without interfacing with the communication node 14′. The operator will enter into this mode through a combination of buttons on the communication node 14 as described previously. The embodiment described herein also may include all of the safety features and additional features previously described such as a door position monitoring device and a tamper notification member.

### DETAILED DESCRIPTION OF FIFTH EMBODIMENT

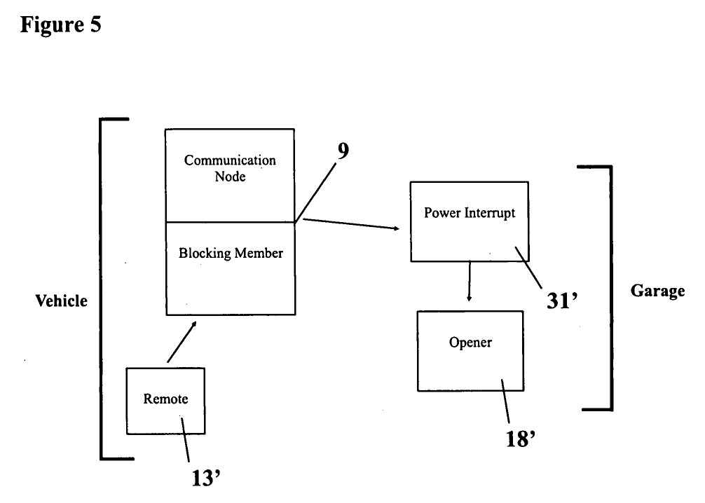

A fifth embodiment as shown in FIG. 5 consists of two primary components; a transceiver that combines a blocking member/communication node 9 located typically on an exterior of a vehicle and a power interrupt device 31′. The power interrupt device 31′ plugs inline with the power supply for an existing garage door opener 18′. This embodiment relies on the operator's existing remote control device 13′ as well as the operator's existing garage door opener 18′. The transceiver 9 for example, detects the presence of an obstruction. When a signal is detected from the remote control device 13′ to open the garage door, the transceiver 9 will then transmit a request to the power interrupt device 31′ to interrupt or disable the power supply to the garage door opener 18′. As a result, the brief interruption in power to the garage door opener 18′ will reset the garage door and prevent it from opening. As described previously, the request to interrupt the power supply is a form of blocking signal, preventing activation and opening of the garage door. The power interrupt device 31′ is mounted within a garage for example, in series with the power cord and outlet for the pre-existing garage door opener or opener circuit 18′, as described previously. The transceiver 9 which is typically mounted on an exterior of a vehicle, senses or receives a signal from the remote control member 13′. If a signal to open is detected from the remote control member 13′, the transceiver 9 then generates a signal to the power interrupt device 31′ to interrupt power to the garage door opener 18′. The power interrupt device 31′ is typically driven by electrical current.

The transceiver 9 typically has two modes of operation: The normal operation consists of the operation as set forth above. In bypass mode, the operator is able to operate the garage door opener 18′ directly regardless of the input from the transceiver 9. The operator will enter into this mode through a combination of actions to prevent the accidental bypass of the blocking member 9.

A typical operation requires an operator to press a touch pad or button on the remote control member 13′ that transmits a wireless radio signal to the garage door opener 18′ when there is no obstruction or object sensed by the transceiver 9. If an object is present and detected by the transceiver 9, a signal is transmitted to the power interrupt device 31′ to interrupt the power supply to the garage door opener 18′. This brief interruption in power to the garage door opener 18′ will reset the garage door and prevent it from opening. The embodiment described herein also may include all of the safety features and additional features previously described such as a door position monitoring device and a tamper notification member.

### DETAILED DESCRIPTION OF SIXTH EMBODIMENT

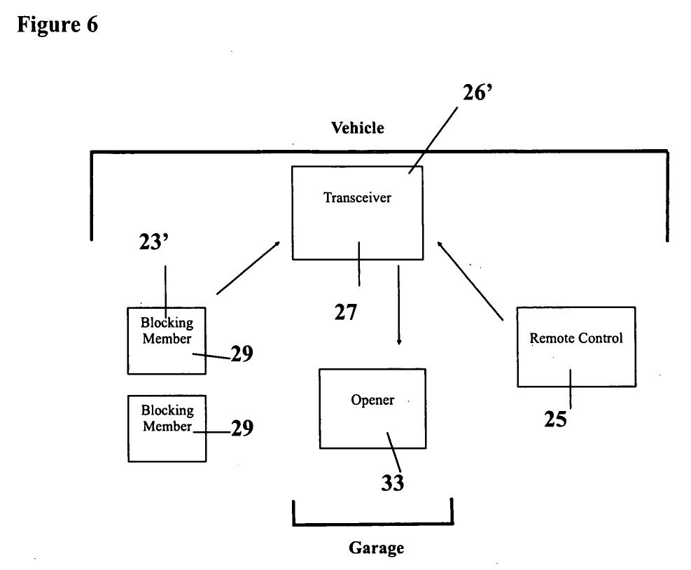

A further embodiment, as shown in FIG. 6, consists of four primary components: A first component is a remote control member 25 that is typically a garage door remote control device similar to those found in most vehicles. For example but not by way of limitation, the garage door remote manufactured by Genie, Craftsman, or Chamberlain may be used but certainly any other remote control device may be used as well. The second, third and fourth components include a transceiver 27 that is also located within the vehicle or near one or more blocking members 29 and is paired with the remote control member 25; and an opener circuit 33 such as a garage door opener. The blocking member 29 located on the roof or side of a vehicle, transmits or generates a signal to the transceiver 27, indicating the presence or absence of an obstruction. The remote control member 25 communicates via wireless or hardwired signal, for example, with the transceiver 27 and the transceiver 27 generates a signal to the opener circuit 33 within the garage. The transceiver 27 is in communication with the one or more blocking members 29. The transceiver 27 is typically a device that is capable of receiving signals as well as transmitting signals. The transceiver 27 receives one or more direct signals from the blocking members 29. The members 29 typically comprise a switch as previously described. A logic circuit 23′ may also be integrated with the blocking members 29 or the transceiver 27 and/or remote control member 25 and may consist of one or more inputs received from the one or more integrated sensors and an output that calls for the transceiver 27 to allow transmission of a signal to the garage door opener 33 to open the garage door or provide an interrupt to the signal to open the same garage door if an object is present.

A bypass switch 26′ either located on the exterior of the vehicle or within the vehicle is necessary to allow the operator to operate the remote control member 25 directly regardless of the input signal from the blocking members 29. The transceiver 27 typically has two modes of operation. The normal operation consists of a typical garage door remote 25 similar to those found in most cars and the transceiving member 27 that operates in conjunction with the blocking members 29. Under normal operation, as shown in FIG. 4, the remote control member 25 interfaces with the transceiver 27. The blocking members 29 also interface with the transceiver 27, signalling the presence or absence of an object. The transceiving member 27 will allow transmission of a signal to the opener circuit 33 such as an existing power driven garage door opener to activate a motor driven garage door or interrupt the signal sent by the transmitter member 25. In bypass mode the operator is able to operate the remote control member 25 directly without interfacing the transceiving member 27 or alternatively, without interference from the blocking members 29. The embodiment described herein also may include all of the safety features and additional features previously described such as a door position monitoring device and a tamper notification member.

It is therefore to be understood that while different embodiments or aspects are herein set forth and described, the above and other modifications may be made therein without departing from the spirit and scope of the invention as defined by the appended claims and reasonable equivalents thereof.

We claim:

1. In a control system for a garage door electrical opener circuit in which a wireless control signal is transmitted remotely from a vehicle to said opener circuit within a garage for opening and closing said garage door, the improvement comprising:
remote control means for transmitting said control signal; and
means on said vehicle for blocking said control signal to said opener circuit.

2. The control system according to claim 1 wherein said blocking means is a switching unit interfacing with said remote control means.

3. The control system according to claim 1 wherein said blocking means interrupts the transmission of said control signal to said opener circuit thereby indicating the presence of an obstruction and preventing opening of said garage door.

4. The control system according to claim 1 wherein said remote control means includes a bypass switch.

5. The control system according to claim 1 wherein said remote control means interfaces with means for monitoring the position of said garage door.

6. The control system according to claim 1 wherein said remote control means interfaces with a switch member.

7. The control system according to claim 6 wherein said switch member is adapted to open or close a switch leg of said opener circuit.

8. The control system according to claim 1 wherein said control system includes a power interrupt member that is in communication with said opener circuit.

9. The control system according to claim 8 wherein said opener circuit includes said power interrupt member, said remote control means and a transceiver.

10. A remote system for indicating the presence of an obstruction on a vehicle and thereby preventing a garage door from opening, comprising:
communication means associated with a vehicle for generating a wireless signal to a receiving member within a garage;
means for indicating the presence of an obstruction on an exterior of said vehicle, said indicating means interfacing with said communication means; and
said receiving member adapted to receive a signal from said communication means for interrupting power transmission to a garage door opener circuit.

11. The signal device according to claim 10 wherein said communication means and said indicating means are housed on an exterior of said vehicle and are adapted to receive a signal from a garage door remote control device.

12. The signal device according to claim 10 wherein said receiving member interfaces with a power interrupt device.

13. The remote system according to claim 10 wherein said indicating means includes an inductive, capacitive, ultrasonic or optical sensor.

14. A remote system for sensing and signalling the presence or absence of an obstruction on a vehicle and transmitting a control signal to an opener circuit thereby controlling the activation of said opener circuit for opening a garage door, said system comprising:
at least one blocking member in or on a vehicle interfacing with a communication node;
said communication node in communication with a transceiver; and
said transceiver interfacing with a power interrupt member and said opener circuit.

15. The remote system according to claim 14 wherein said communication node is adapted to receive a beacon signal when in range of said signal.

16. The remote system according to claim 14 including a visual or audible alarm within said vehicle.

17. A novel and improved apparatus for preventing activation of a garage door opener circuit by a remote control device, said improvement comprising:
means for sensing and signalling the presence of an obstruction on a vehicle exterior;
a transceiver located within said vehicle and adapted to receive a signal from said sensing and signalling means; and
said signal preventing activation of said garage door opener circuit.

18. The improvement according to claim 17 wherein said sensing and signalling means includes a rack sensor and a tamper indication member.

19. The improvement according to claim 17 wherein said transceiver member interfaces with said remote control device and said sensing and signalling means interrupt transmission of said signal to said opener circuit in response to the presence of an obstruction.

20. A method of interrupting a garage door activation signal to an opener circuit, the signal causing the opener circuit to open a garage door, the method comprising;
activating a blocking member on an exterior of said vehicle in response to an obstruction within range of said blocking member;
generating a signal from said blocking member when said blocking member is activated; and
transmitting said signal to a remote control member thereby interrupting said activation signal to prevent opening of said garage door.

21. The method according to claim 20 wherein said blocking member is defined by means for interrupting transmission of said activation signal between said remote control device and said opener circuit thereby preventing said garage door from opening when said blocking member is activated.

22. The method according to claim 20 including interrupting said activation signal to said opener circuit with a power interrupt device.

23. The method according to claim 20 including mounting a wall switch member within said garage, said wall switch member interfacing with said remote control device and said opener circuit.

24. The method according to claim 23 including closing a circuit on said wall switch member thereby disrupting said activation signal between said remote device and said opener circuit.

25. The method according to claim 20 wherein said remote control device includes means for bypassing said signal generated from said blocking member.
